(19) United States
(12) Patent Application Publication
(10) Pub. No.: US 2007/0283588 A1
(43) Pub. Date: Dec. 13, 2007

(54) Push mark

(76) Inventors: Adam G. Gardner, Albuquerque, NM (US); Marina Gardner, Albuquerque, NM (US)

Correspondence Address: Galasso & Associates, LP, P.O. Box 26503, Austin, TX, 78755-0503, US

(21) Appl. No.: 11/451,041

(22) Filed: Jun. 12, 2006

(51) Int. Cl. G01D 21/00

(52) U.S. Cl. 33/666; 33/613

(57) ABSTRACT

Push Mark consists of a pin with an adhesive coating or other attachment mechanism. The adhesive coating of the head or other attachment mechanism is attached to the back of a picture frame or other hanging instrument in approximately the spot where a nail or hanger will support it against a wall. Once the adhesive coating or other attachment mechanism is put in place, the frame or other hanging instrument is pressed firmly against the wall, allowing the pin to leave a mark where the nail or nails will be placed for hanging the frame or instrument.

### CROSS REFERENCE TO RELATED APPLICATIONS

This Non-Provisional Patent Application does not claim priority to any U.S. provisional application or any foreign patent applications.

### FIELD OF THE DISCLOSURE

The disclosures made herein relate generally to the household accessory industry. The invention discussed herein is in the general classification of picture-hanging devices.

### BACKGROUND

Many individuals take great pleasure and pride in decorating their homes with rugs, plants, fixtures, lamps and other objects. Many persons also choose to accessorize their house with various paintings, pictures, diplomas or other knickknacks that must be hung on a wall. Often, hanging a frame or other object entails at least some trial and error, guesswork or a lengthy process of measuring and leveling. The ordinary manner of picture hanging can lead to frustration and often multiple holes in a wall that need to be filled after the hanging is complete.

Hence, there is a need in the art for an easy to use device for hanging pictures or other items that is inexpensive, effective and takes the guesswork out of the process. SUMMARY OF THE DISCLOSURE

Push Mark consists of at least some of the following: a head attached to a pin on one side and having an adhesive coating on the other side or a pin with an attachment mechanism. The adhesive coating of the head or attachment mechanism is attached to the back of a picture frame or other hanging instrument in approximately the spot where a nail or hanger will support it. Once the adhesive coating or other attachment mechanism is in place, the frame is pressed firmly against the wall, allowing the pin to leave a mark where the nail or nails will be placed for hanging the frame or other instrument.

The principal object of this invention is to provide a picture-hanging device that allows a user to easily mark locations on a wall for inserting nails or hangers.

Another object of this invention is to provide an affordable picture-hanging device.

Another object of this invention is to provide a picture-hanging device that will not unnecessarily mark or create abrasions on a wall.

Yet another object of this invention is to provide a device that allows efficient hanging of pictures or other items on a wall.

### BRIEF DESCRIPTION OF THE DRAWINGS

FIG. 1 depicts a frontal perspective view of the preferred embodiment of the invention.

FIG. 2 depicts a rear perspective view of the preferred embodiment of the invention.

FIG. 3 depicts a cross-sectional view of cut along the line A-A shown in FIG. 1.

### DETAILED DESCRIPTION OF THE DRAWINGS

The preferred embodiment of Push Mark is comprised of at least some of the following: a head with a pin protruding from or attached to one side and an adhesive coating on the other side. A foam layer or other type of cushioned layer with an adhesive strip and protective coating may also be utilized.

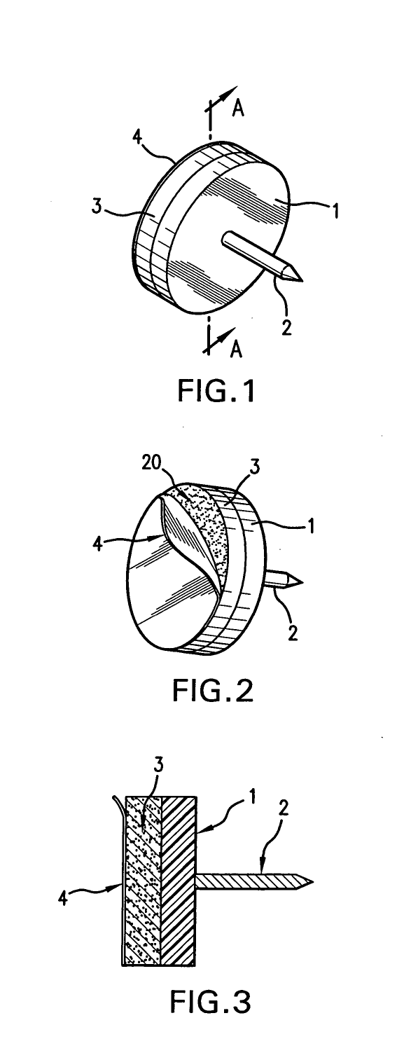

In the preferred embodiment of the invention, shown in FIG. 1, an approximately circular head 1 made of plastic has a pin 2 protruding from approximately the center on one side. The pin 2 is made of metal in this preferred embodiment. On the other side of the head 1, an approximately circular foam disc 3 is attached. The outer side of the foam disc 3 has an adhesive coating (not shown) and a protective film 4 that can be peeled away to reveal the adhesive coating. The adhesive coating and protective film 4 are also approximately circular in shape and cover the entirety of the foam disc 3.

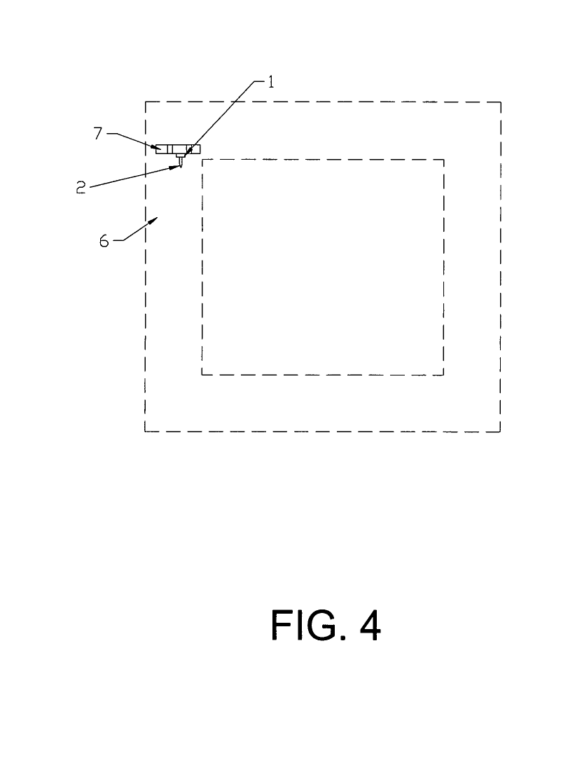

FIG. 2 shows a rear perspective view of the preferred embodiment of the invention. The head 1, pin 2, foam disc 3 and protective film 4 are still visible. The protective film 4 is shown as it is peeling away from the foam disc 3, revealing the adhesive coating 20.

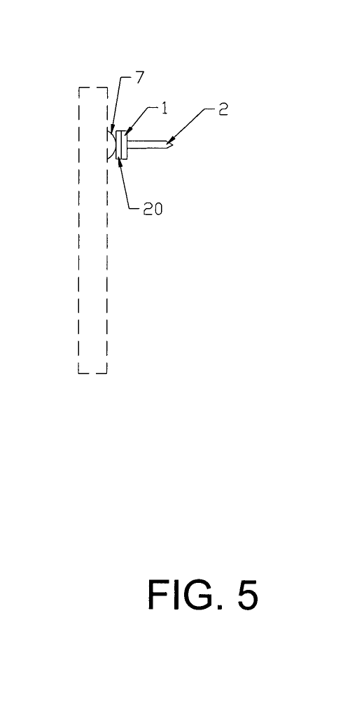

FIG. 3 shows a cross-sectional view cut along the line A-A of FIG. 1. This shows in greater detail the different layers of the preferred embodiment of the invention. The pin 2 protrudes from the head 1 on one side. On the other side of the head 1, a foam disc 3 is attached, having a protective film 4 that is removed when the invention is used.

In order to use Push Mark, one would first choose a picture, painting or other wall-hanging item and a location to hang the item within a home, office, store or other structure. Depending on the weight and size of the wall-hanging item, one, two, or even more Push Marks may be used. The protective film of the adhesive coating on the foam layer is removed and each Push Mark is placed on the location on the frame or other wall-hanging item where nails will eventually be used. The foam layer provides protection for the frame against damage. The frame or item is then pressed evenly against the wall in the chosen location, resulting in a small score from the pin. This will mark the location where nails will be placed. Push Marks are then removed from the frame or item and discarded. Nails or hangers with nails are then hammered into place at the locations designated and the frame or other item is hung on the wall.

In an alternative use of the invention, a strong adhesive coating can be used on the head or on the foam layer of the head, allowing Push Marks to stay in place permanently on the frame or other object. As a result, the pin can simply be used to hang the frame or other item rather than utilizing a separate hanger or nail. This type of hanging will work best with smaller, lighter items that need to be hung on a wall.

In yet another embodiment of the invention, a hinged metal spike or other type of pin that can be folded into and out of position can be attached to the frame. The spike could be folded down into a locked position perpendicular to the frame when it was being used to create an imprint in the wall. After this task is completed, the user could simply fold the spike back up, approximately parallel to the frame, and a nail could be inserted in the imprinted location. This variant could be sold as an accessory in stores or could be permanently attached to the frame by a frame manufacturer.

The components of Push Mark may vary widely but will likely include plastic, metal, foam and other components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Push Mark can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the head, pin and other components of the present invention can be of various shapes and sizes. The preferred embodiment of the head and foam disc are approximately 13/16 inch in diameter and 1/16 inch in width. The pin is approximately ½ inch in length.

It should also be obvious that the components of the invention can be made of different types of plastics or other suitable materials and can be of any color. For example, the pin could be made of plastic instead of metal. It should further be obvious that while the device discussed herein is generally used to hang pictures, it could be used to hang anything. It should also be obvious that the foam disc with adhesive coating could be replaced by simply making the head of the pin adhesive or by creating another mechanism for attaching the head to the desired object. However, in the preferred embodiment, a foam layer or other cushioning item is used to minimize damage to the frame or other hanging instrument.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A hanging device comprising:
(a) a head attached on a first side to a pin;
(b) an adhesive coating on a second side of the head; and
(c) a hinge mechanism capable of being attached to a picture frame and the head; and wherein the pin can rotate from approximately parallel to the frame to approximately perpendicular to the frame.

2. The hanging device of claim 1 wherein the pin is metal.

3. The hanging device of claim 1 wherein the pin is plastic.

4. The hanging device of claim 1 wherein the head is metal.

5. The hanging device of claim 1 wherein the head is plastic.

6. The hanging device of claim 1 wherein the head is approximately circular.

7. The hanging device of claim 1 wherein the head is approximately rectangular.

8. The hanging device of claim 1 wherein the pin is attached to approximately the center of the first side of the head.

9. The hanging device of claim 1 further comprising
a layer attached to the second side of the head opposite the pin wherein the exterior of the layer is covered by a second adhesive with a protective film.

10. The hanging device of claim 9 wherein the layer is foam.

11. The hanging device of claim 6 further comprising
a foam disc attached to the second side of the head opposite the pin wherein the exterior of the foam disc is covered by an approximately circular adhesive coating and an approximately circular protective film.

12. A hanging device comprising:
(a) a plastic and circular head that is attached on a first side to a metal pin located in approximately the center of the plastic and circular head;
(b) a foam and circular disc that is attached to a second side of the plastic and circular head opposite the metal pin;
(c) an adhesive coating on the foam and circular disc; and
(d) a removable protective film attached to the adhesive coating; and
(e) a hinge mechanism which is attached to the adhesive coating on one side once the protective coating is removed and a frame on a second side and which is capable of rotating from a position substantially parallel with the frame to a position substantially perpendicular.

13. (canceled)

14. (canceled)
